(19) United States
(12) Patent Application Publication
(10) Pub. No.: US 2026/0350035 A1
(43) Pub. Date: Nov. 5, 2026

(54) DERIVED TIME SERIES

(71) Applicant: Palantir Technologies Inc., Denver, CO (US)

(72) Inventors: Meghan Nayan, Seattle, WA (US); Paul Nepywoda, Los Altos, CA (US); Jamie Sookprasong, Seattle, WA (US); Daniel Younghoon, San Francisco, CA (US); Julianne Wagoner, New York, NY (US); Alexander Dales, New York, NY (US); Zachary Schadt, New York, NY (US); David Tobin, Atherton, CA (US); Jonathan Yu, South San Francisco, CA (US); Rory Grant, Seattle, WA (US)

(21) Appl. No.: 19/209,129

(22) Filed: May 15, 2025

Related U.S. Application Data
(60) Provisional application No. 63/798,449, filed on May 1, 2025.

(51) Int. Cl. G06F 16/25; G06F 16/22; G06F 16/28

(52) U.S. Cl. CPC G06F 16/258; G06F 16/22; G06F 16/287

(57) ABSTRACT

A device may access a time series dataset associated with a machine object having a first object type, the time series including a plurality of data values each associated with a respective timestamp. A device may provide a user interface configured to receive user input selecting or defining transformation logic usable to transform the time series dataset. A device may generate a derived time series dataset based on the time series dataset and the transformation logic. A device may provide for display a visualization of the derived time series dataset. A device may store the transformation logic as an object in an ontology database in association with a first machine object and a plurality of other machine objects of the first object type, wherein the transformation logic is selectable by any of a plurality of users accessing any of the plurality of machine objects of the first type.

### TECHNICAL FIELD

The present disclosure relates to systems and techniques for data integration, analysis, and visualization.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Time series data can be transformed by formula logic. The transformed data can be displayed to the user. Various techniques have been developed to minimize the effort required by a human user in transforming mass object data.

### SUMMARY

The systems, methods, and devices described herein each have several aspects, no single one of which is solely responsible for its desirable attributes. Without limiting the scope of this disclosure, several non-limiting features will now be described briefly.

A time series is a series of measurements taken over a period of time. The series of measurements associated with the time series can be transformed to create a new or modified time series. However, creating the transformation logic for the time series can be time consuming and difficult for the user. For example, current techniques require the user to have back-end development knowledge to create a pipeline transformation for each time series object. Moreover, the created transformation logic is not savable or transferable to other similar time series objects, therefore the user would have to recreate the transformation logic for each of the time series objects they want to modify. Additionally, the data for each transformed time series logic would be saved in the database, wasting storage space and slowing down processing.

The present disclosure implements systems and methods (generally referred to herein as “a derived time series system” or simply a “system”) that can advantageously overcome the technical challenges mentioned above, among other technical challenges. The present disclosure further includes various processes, functionality, and interactive graphical user interfaces (hereinafter a “GUI”) related to the system. The system can advantageously provide an efficient and user-friendly process for quickly creating a derived time series for a type of input, storing the derived time series in the database, and associating the derived time series with other objects of the same type, as described herein. For example, according to various implementations, the system, (and related processes, functionality, and interactive GUIs), can advantageously create a derived time series that is capable of taking input data of a specified type and transforming it in a specified way. The derived time series can be stored in the ontology (e.g., stored information that provides a data model for storage of data in one or more databases) as an object (e.g., a data container for information representing specific things in the world that have a number of definable properties). The system can then automatically provide the stored derived time series object when the user is working with input data of the same type.

Accordingly, in various embodiments, large amounts of data are automatically and dynamically calculated interactively in response to user inputs, and the calculated data is efficiently and compactly presented to a user by the system. Thus, in some embodiments, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, design of computer user interfaces that are useable and easily learned by humans is a non-trivial problem for software developers. The various embodiments of interactive and dynamic user interfaces of the present disclosure are the result of significant research, development, improvement, iteration, and testing. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interfaces described herein may provide an optimized display of time-varying report-related information and may enable a user to more quickly access, navigate, assess, and digest such information than previous systems.

In some embodiments, data may be presented in graphical representations, such as visual representations, such as charts and graphs, where appropriate, to allow the user to comfortably review the large amount of data and to take advantage of humans' particularly strong pattern recognition abilities related to visual stimuli. In some embodiments, the system may present aggregate quantities, such as totals, counts, and averages. The system may also utilize the information to interpolate or extrapolate, e.g. forecast, future developments.

Further, the interactive and dynamic user interfaces described herein are enabled by innovations in efficient interactions between the user interfaces and underlying systems and components. For example, disclosed herein are improved methods of receiving user inputs, translation and delivery of those inputs to various system components, automatic and dynamic execution of complex processes in response to the input delivery, automatic interaction among various components and processes of the system, and automatic and dynamic updating of the user interfaces. The interactions and presentation of data via the interactive user interfaces described herein may accordingly provide cognitive and ergonomic efficiencies and advantages over previous systems.

Various embodiments of the present disclosure provide improvements to various technologies and technological fields. For example, as described above, existing data storage and processing technology (including, e.g., in memory databases) is limited in various ways (e.g., manual data review is slow, costly, and less detailed; data is too voluminous; etc.), and various embodiments of the disclosure provide significant improvements over such technology. Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, and presentation of the updates to displayed images via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

Certain embodiments of a derived time series environment discussed herein may include any combination of the technical features below:

### Derived Time Series Logic Features

Parameterized Inputs: a derived time series may be generated based on transformation logic that is applied at runtime using parameterized inputs, ensuring up-to-date results and decoupling the logic from input values.
Input Types: Inputs can be either time series or static values, referenced via the ontology. For example, a derived time series can reference expressions like $a*10 or $a*$b, where $a is a time series property and $b is a non-time series property used in runtime calculations.
Data Types: Supports both numerical and categorical series as inputs and outputs.
Nested Derived Series: The logic supports nested derived series, allowing expressions such as $a*$d1 where $a is a raw time series and $d1 is a derived time series.
Aggregation Support: Capable of aggregating across raw and derived time series.

### Derived Time Series Management Features

Version Control: Users can view current and previous versions of transformation logic and metadata for a derived time series.
Metadata Editing: Users can edit metadata, including transformation logic name and description.
Logic Editing: Users can edit the transformation logic, including non-visual configuration of time series (e.g., represented by time series) cards, such as rolling aggregate cards or time series formula cards.
Logic Flow Enhancement: Users can add new time series cards within the transformation logic.
Change Tracking: Users can view differences in logic, ontology, and metadata.
Ontology Settings Management: Users can view and edit ontology settings for the derived time series, including the object type against which a transformation logic will be ontologized.

Additional embodiments of the disclosure are described below in reference to the appended claims, which may serve as an additional summary of the disclosure.

In various embodiments, systems and/or computer systems are disclosed that comprise a computer readable storage medium having program instructions embodied therewith, and one or more processors configured to execute the program instructions to cause the one or more processors to perform operations comprising one or more aspects of the above-and/or below-described embodiments (including one or more aspects of the appended claims).

In various embodiments, computer-implemented methods are disclosed in which, by one or more processors executing program instructions, one or more aspects of the above-and/or below-described embodiments (including one or more aspects of the appended claims) are implemented and/or performed.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above-and/or below-described embodiments (including one or more aspects of the appended claims).

### BRIEF DESCRIPTION OF THE DRAWINGS

FIG. 1A is a block diagram illustrating a data management system, according to some embodiments of the present disclosure.

FIG. 1B is a block diagram illustrating an example time series dataset transformation, according to some embodiments of the present disclosure.

FIG. 1C is a block diagram illustrating example components of a data management system, according to some embodiments of the present disclosure.

FIG. 2 illustrates one embodiment of a database system using an ontology.

FIG. 3 illustrates an example user interface displaying multiple time series and a derived time series, according to some embodiments of the present disclosure.

FIG. 4 illustrates an example user interface displaying a categorical time series, according to some embodiments of the present disclosure.

FIG. 5 illustrates an example user interface displaying creation of a derived time series, according to some embodiments of the present disclosure.

FIG. 6A illustrates an example user interface displaying a comparison of a previous transformation logic and current transformation logic applied to a time series, according to some embodiments of the present disclosure.

FIG. 6B illustrates an example user interface configured to display linked ontology changes, according to some embodiments of the present disclosure.

FIG. 7 illustrates an example user interface displaying file system information for storing derived time series.

FIG. 8 is a flowchart of one embodiment of a process for creating a derived time series.

FIG. 9 is a block diagram illustrating a computer system with which certain methods discussed herein may be implemented, according to some embodiments of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

In some aspects and/or embodiments, systems, methods, and computer program products described herein include and/or implement the ability to create derived time series logic that can be stored in the ontology to be called and implemented by other objects. The user may create the derived time series based on the specific input data that the user wants to transform. For example, a user may want to determine the average temperature of a machine over the span of thirty days. In such an example, the user can create a derived time series with formula logic that takes the rolling aggregate of the machine temperature for a span of thirty days. The user may then store the created derived time series logic in the ontology to be used again with different machines.

To facilitate an understanding of the systems and methods discussed herein, a number of terms are described below. The terms described below, as well as other terms used herein, should be construed to include the provided descriptions, the ordinary and customary meaning of the terms, and/or any other implied meaning for the respective terms. Thus, the descriptions below do not limit the meaning of these terms but only provide exemplary descriptions.

Ontology: Stored information that provides a data model for storage of data in one or more databases. For example, the stored data may comprise definitions for data object types and respective associated property types. An ontology may also include respective link types/definitions associated with data object types, which may include indications of how data object types may be related to one another. An ontology may also include respective actions associated with data object types. The actions associated with data object types may include, e.g., defined changes to values of properties based on various inputs. An ontology may also include respective functions, or indications of associated functions, associated with data object types, which functions, e.g., may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types.

Data Store: Any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

Database: Any data structure (and/or combinations of multiple data structures) for storing and/or organizing data, including, but not limited to, relational databases (e.g., Oracle databases, PostgreSQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores.

Data Object or Object: A data container for information representing specific things in the world that have a number of definable properties. For example, a data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object's attributes (e.g. metadata about the object) may be represented in one or more properties.

Object Type: Type of a data object (e.g., Person, Event, or Document). Object types may be defined by an ontology and may be modified or updated to include additional object types. An object definition (e.g., in an ontology) may include how the object is related to other objects, such as being a sub-object type of another object type (e.g. an agent may be a sub-object type of a person object type), and the properties the object type may have.

Properties: Attributes of a data object that represent individual data items. At a minimum, each property of a data object has a property type and a value or values.

Property Type: The type of data a property is, such as a string, an integer, or a double. Property types may include complex property types, such as a series data values associated with timed ticks (e.g. a time series), etc.

Property Value: The value associated with a property, which is of the type indicated in the property type associated with the property. A property may have multiple values.

Link: A connection between two data objects, based on, for example, a relationship, an event, and/or matching properties. Links may be directional, such as one representing a payment from person A to B, or bidirectional.

Link Set: Set of multiple links that are shared between two or more data objects.

Time series dataset (or “time series”): A sequence of data points representing observations (e.g., sensor measurements) recorded at successive points or intervals in time. Each data point includes a timestamp and a corresponding value. Time series data is typically collected at fixed intervals (e.g., seconds, minutes, hours, days) but may also be irregularly spaced depending on the application.

Transformation logic (or “time series logic”): An algorithm, formula, or other logic usable to transform a time series into a derived time series. Transformation logic can be applied to each of the measurements of a time series or to a filtered set of measurements. Transformation logic may perform operations such as smoothing (e.g., reduces noise and fluctuations to highlight underlying patterns), averaging (e.g., calculates mean values over specified intervals to mitigate the effects of outliers and anomalies), normalization (e.g., rescales data to a standardized range to facilitate comparisons, interpolation (e.g., estimates missing values based on existing data points), differentiation (e.g., computes rate-of-change metrics to capture dynamic variations), aggregation (e.g., consolidates multiple data points into representative summaries for trend analysis), categorizing (e.g., summarized groups of time series data based on category, such as ranges of time series values), and/or the like. Transformation logic may be stored in a transformation logic database and/or in an ontology database of a data management system (e.g., as a data object that is stored according to an ontology, such as in association with related data objects).

Derived time series dataset (or “derived time series data” or “derived time series”): A derived time series is created by application of transformation logic to a time series. For example, a derived time series may include smoothed, averaged, normalized, differentiated, aggregated, and/or categorized representations of the original time series.

### Example System and Related Computing Environment

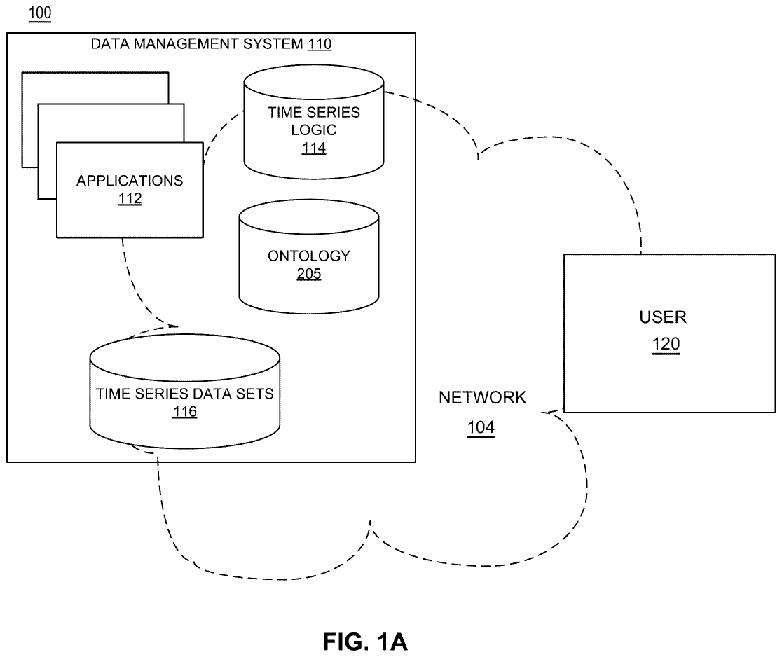

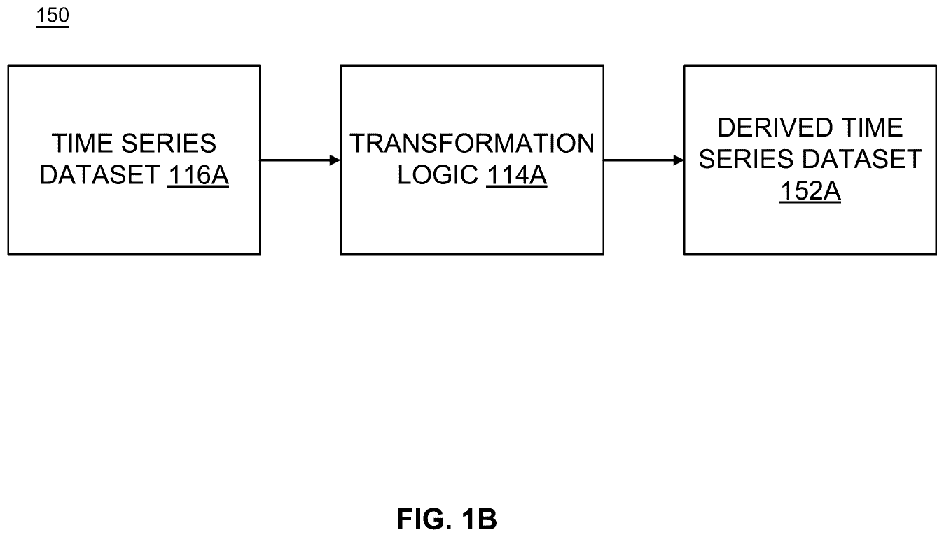

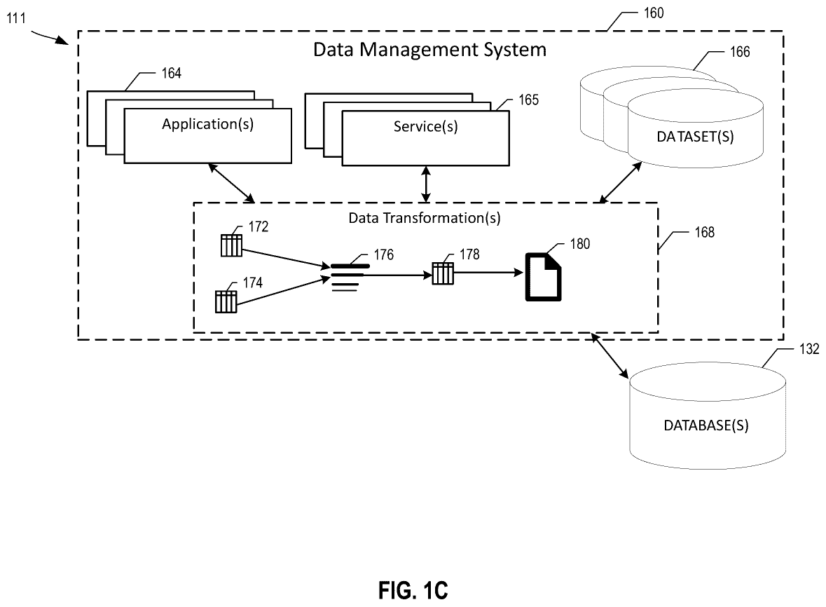

FIG. 1 illustrates a block diagram of an example derived time series computing environment 100. In the illustrated example, the computing environment 100 includes a user 120 and a database management system 110. Moreover, the database management system 110 comprises various modules, including one or more applications 112, a transformation logic database 114, a time series database 116, and an ontology 205.

In the example of FIG. 1, the user 120 and database management system 110 are in communication via a network 104, which may include any combination of networks, such as one or more personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some cases, the network 104 may be a private or semi-private network, such as a corporate or university intranet. The network 104 may include one or more wireless networks, such as a Global System for Mobile Communications (GSM) network, a Code Division Multiple Access (CDMA) network, a Long-Term Evolution (LTE) network, or any other type of wireless network. The network 104 can use protocols and/or components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and/or the like.

In some embodiments, modules of the illustrated components, such as the one or more applications 112, the transformation logic database 114, the time series database 116, and/or the ontology 205, may communicate via an internal bus and/or via the network 104.

The one or more applications 112 may include applications that enable the user 120 to search for, analyze, and/or interact with time series data, such as raw time series data and/or derived time series data. For example, the one or more applications 112 may allow the user 120 to select and view a time series dataset to which a transformation should be applied. For example, the user 120 may want to view an average rolling temperature for a machine object that is derived from temperature time series data. In this example, the user 120 can create an average rolling temperature derived time series by creating an average rolling transformation logic and applying it to the temperate time series data. The transformation logic may be stored in the transformation logic database 114 and later accessed and applied to other data sets by the same user or another authorized user. Similarly, the user 120 can select an already created average temperature transformation logic, or any other transformation logic, stored in the transformation logic database 114, to apply to the temperature time series data.

The one or more applications 112 may also include an application that enables the user 120 to interact with derived time series datasets (or simply “derived datasets” or “derived time series”) that result from application of various transformation logic that has been applied to a selected time series dataset (or simply “time series”). In the above example, after creating a derived time series using an average rolling temperature transformation logic, the application may display to the user 120, via a GUI, the average rolling temperature of the machine object, such as for a previous thirty days. In this example, the user 120 can view the derived time series and may choose to transform the input time series data in a different way. In such cases, the user 120 can repeat the above process to create another derived time series with new transformation logic (e.g., calculating the delta pressure for inlet and outlet pressure time series data) and can now view (via the GUI) the newly transformed data. Additionally or alternatively, the user 120 may also choose to modify the temperature derived time series to display the average rolling temperature of the machine object over a different time period, e.g., previous forty days.

In some embodiments, transformation logic is stored according to an ontology, e.g., as a data object in an ontology database, without storing the (calculated) derived time series data (calculated based on application of the transformation logic to a time series dataset). In this example, each time a user requests a derived data set, the transformation logic data object may be accessed in the ontology and used to compute the derived time series data on demand. In some examples, the derived time series data may only be used on the local computing device where it is requested, and re-generated each time the derived time series is requested by that same computing device and/or any other computing device.

In some embodiments, the (calculated) derived time series data is stored in the ontology database in addition to, or as an alternate to, storage of the transformation logic that can be applied to time series data on demand. For example, with reference to the example above the user 120 may choose to store their created average rolling temperature derived time series as an object, such as may be defined by the ontology 205. Thus, the derived time series may be stored in association with other related object types (e.g., per the ontology 205) and recalled based on relationships with those other related object types.

In some implementations, an application may be configured to allow generating a derived time series from an existing derived time series. For example, a first derived time series may be created using a first transformation logic (e.g., an average rolling transformation logic) applied to a raw time series and then create a second derived time series by applying a second transformation logic (e.g., exponential smoothing, Fourier analysis, or log transformations) to the first derived time series, thereby generating a second derived time series.

The one or more applications 112 may also include an application that enables the user 120 to search the time series database 116, transformation logic database 114, or ontology 205 for previously created derived time series, objects with specific input data types, and/or any other stored object in the ontology database. For example, the user 120 can search the time series database 116 for previously created transformation logic (e.g., created by another user) that is associated with a selected raw time series data. As one example, the user 120 may have temperature time series data for a machine object. The user 120 may want to transform the time series data in various ways (e.g., average rolling temperature, delta temperature, derivative, etc.) and can search the transformation logic database 114 to find previously created transformation logic that is linked to the temperature time series property (e.g., in the ontology) and can transform the time series data accordingly.

The transformation logic database 114 may store a plurality of the transformation logic that can be selected and re-used by the user 120. Each transformation logic can include one or more rules, formulas, algorithms, etc. for generating derived time series. Transformation logic may be associated with particular time series parameters to which the transformation logic may be applied. For example, the transformation logic can be a rule or algorithm for finding an average rolling temperature when time series data is temperature. When the user selected a temperature time series of an object, such as a machine object, the average rolling temperature transformation logic may automatically be shown as available for application to the temperature time series because the data type is temperature data.

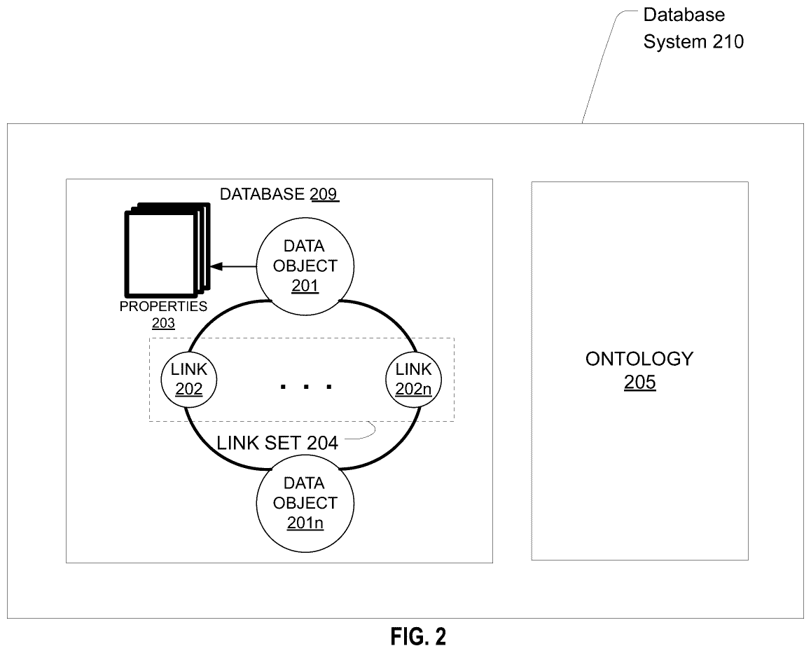

As another example, transformation logic to find the derivative of a time series with time series properties that match the average rolling temperature derived time series may already be created and/or stored in the transformation logic database 114. In this example, properties of the average rolling temperature derived time series and the derivative transformation logic may match such that the derived transformation logic is automatically provided to the user 120 as available for transformation of the rolling temperature derived time series. Associations between data objects is described in more detail herein with reference to FIG. 2.

The transformation logic database 114 can store the “scope” of objects that the user 120 intends the transformation logic to be applied to. For example, ten out of fifty available machine objects may contain inlet and outlet pressure data, while the remaining machines do not. In this example, the user 120 can narrow the machine objects that the created transformation logic associates with by setting the scope of the transformation logic to include machine objects that contain the correct input data (e.g., inlet and outlet pressure). By setting the scope alongside the root object type of machine object, the user 120 can create templated transformation logic that can apply to any machine object with time series property types of inlet and outlet pressure.

The ontology 205 can be configured to store machine object properties and/or their associations (e.g., with the stored transformation logic). As an example, the ontology 205 can store machine object input type properties and derived time series properties. If the machine object input properties match (e.g., “associate with”) the stored derived time series properties, the ontology 205 can create an association between them, and the system can automatically provide the derived time series object to the user 120 as an available transformation. The ontology 205 is described in more detail herein with respect to FIG. 2.

The time series database 116 is configured to store the time series dataset and/or derived time series dataset. The time series database 116 can store the various components of a time series and/or derived time series that allow the system to associate the transformation logic with input data. For example, the time series dataset 116 can store the root object type (e.g., the machine objects stored in the ontology 205) and/or the linked sensor object types (e.g., a time series property type that consists of a singular time series property).

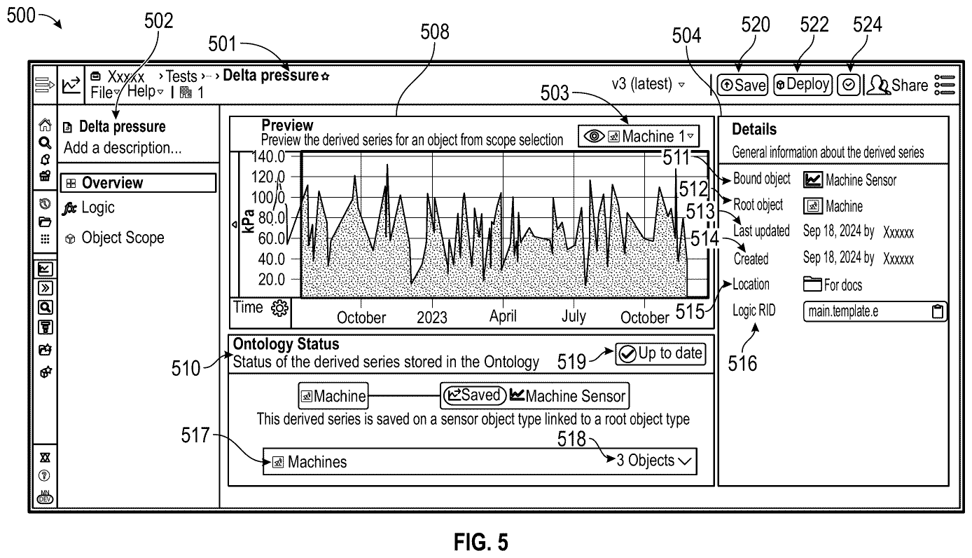

The user 120 may also set values for metadata information such as the derive time series' name, interpolation, unit, and/or any other similar metadata. Setting the metadata information is described in more detail herein with respect to FIG. 5.

FIG. 1B illustrates an example data transformation 150 for transforming a time series into a derived time series. In particular, the illustrated example data transformation 150 can be performed by the derived time series computing environment 100 described above with respect to FIG. 1A. In the embodiment of FIG. 1B, an example transformation logic 114A (e.g., smoothing, averaging, normalizing, interpolating, etc.) may be automatically or manually selected by the user and applied to the time series dataset 116A to generate the derived time series dataset 152A.

As one example, the time series dataset 116A may be temperature data over time for a machine object and the user 120 may want to create a derived time series of the average rolling temperature for the machine object. The user 120 may select transformation logic 114A from the transformation logic database 114 that is configured to find the average rolling temperature when given temperature as an input. The transformation logic 114A may then be applied to the time series dataset 116A to generate an average rolling temperature derived time series dataset 152A. The average rolling temperature derived time series dataset 152A can then be stored in the time series database 116 and can be transformed and/or displayed in the same way as any other time series.

Alternatively, if transformation logic configured to find the average rolling temperature of a time series does not currently exist in the transformation logic database 114, the user 120 may choose to create a new transformation logic that can find the average rolling temperature and subsequently save it to the transformation logic database 114, as described herein.

FIG. 1C illustrates an example data management system 160 for use with a derived time series system, according to some embodiments of the present disclosure. In particular, the database management system 110 (FIG. 1A) may include some or all of the components of the data management system 160. In the embodiments of FIG. 1C, a computing environment 111 can be similar to, overlap with, and/or be used in conjunction with the derived time series computing environment 100 of FIG. 1. For example, the computing environment 111 can include a database 166 and 132, which may be similar to the time series database 116 and/or transformation logic database 114 of FIG. 1A.

The example data management system 160 includes one or more applications 164, one or more services 165, one or more initial datasets 166, and a data transformation process 168 (also referred to herein as a build process). The data management system 160 can transform data and/or record the data transformations. The one or more applications 164 can include applications that enable users to view datasets, interact with datasets, filter datasets, and/or configure dataset transformation processes or builds. The one or more services 165 can include services that can trigger the data transformation builds and API services for receiving and transmitting data. The one or more initial datasets 166 can be automatically retrieved from external sources and/or can be manually imported by a user. The one or more initial datasets 166 can be in many different formats such as a tabular data format (SQL, delimited, or a spreadsheet data format), a data log format (such as network logs), or time series data (such as sensor data).

The data management system 160, via the one or more services 165, can apply the data transformation process 168. An example data transformation process 168 is shown. The data management system 160 can receive one or more initial datasets 172, 174. The data management system 160 can apply a transformation to the dataset(s). For example, the data management system 160 can apply a first transformation 176 to the initial datasets 172, 174, which can include joining the initial datasets 172, 174 (such as or similar to a SQL JOIN), and/or a filtering of the initial datasets 172, 174. The output of the first transformation 176 can include a modified dataset 178. A second transformation of the modified dataset 178 can result in an output dataset 180, such as a report or a joined table in a tabular data format that can be stored in the database 132. Each of the steps in the example data transformation process 168 can be recorded by the data management system 160 and made available as a resource to the one or more applications 164, 112. For example, a resource can include a dataset and/or a dataset item, a transformation, or any other step in a data transformation process. As mentioned above, the data transformation process or build 158 can be triggered by the data management system 160, where example triggers can include nightly build processes, detected events, or manual triggers by a user (such as, user 120). Additional aspects of data transformations and the data management system 160 are described in further detail below.

The techniques for recording and/or transforming data in the data management system 160 may include maintaining an immutable history of data recording and transformation actions such as uploading a new dataset version to the data management system 160 and transforming one dataset version to another dataset version. The immutable history is referred to herein as “the catalog.” The catalog may be stored in a database. Preferably, reads and/or writes from and to the catalog are performed in the context of ACID-compliant transactions supported by a database management system. For example, the catalog may be stored in a relational database managed by a relational database management system that supports atomic, consistent, isolated, and durable (ACID) transactions.

The catalog can include versioned immutable “datasets.” More specifically, a dataset may encompass an ordered set of conceptual dataset items. The dataset items may be ordered according to their version identifiers recorded in the catalog. Thus, a dataset item may correspond to a particular version of the dataset. A dataset item may represent a snapshot of the dataset at a particular version of the dataset. As a simple example, a version identifier of ‘1’ may be recorded in the catalog for an initial dataset item of a dataset. If data is later added to the dataset, a version identifier of ‘2’ may be recorded in the catalog for a second dataset item that conceptually includes the data of the initial dataset item and the added data. In this example, dataset item ‘2’ may represent the current dataset version and is ordered after dataset item ‘1’.

As well as being versioned, a dataset may be immutable. That is, when a new version of the dataset corresponding to a new dataset item is created for the dataset in the system, pre-existing dataset items of the dataset are not overwritten by the new dataset item. In this way, pre-existing dataset items (i.e., pre-existing versions of the dataset) are preserved when a new dataset item is added to the dataset (i.e., when a new version of the dataset is created). Note that supporting immutable datasets is not inconsistent with pruning or deleting dataset items corresponding to old dataset versions. For example, old dataset items may be deleted from the system to conserve data storage space.

A version of dataset may correspond to a successfully committed transaction against the dataset. In these embodiments, a sequence of successfully committed transactions against the dataset corresponds to a sequence of dataset versions of the dataset (i.e., a sequence of dataset items of the dataset).

A transaction against a dataset may add data to the dataset, edit existing data in the dataset, remove existing data from the dataset, or a combination of adding, editing, or removing data. A transaction against a dataset may create a new version of the dataset (i.e., a new dataset item of the dataset) without deleting, removing, or modifying pre-existing dataset items (i.e., without deleting, removing, or modifying pre-existing dataset versions). A successfully committed transaction may correspond to a set of one or more files that contain the data of the dataset item created by the successful transaction. The set of files may be stored in a file system.

In the catalog, a dataset item of a dataset may be identified by the name or identifier of the dataset and/or the dataset version corresponding to the dataset item. In a preferred embodiment, the dataset version corresponds an identifier assigned to the transaction that created the dataset version. The dataset item may be associated in the catalog with the set of files that contain the data of the dataset item. In a preferred embodiment, the catalog treats the set of files as opaque. That is, the catalog itself may store paths or other identifiers of the set of files but may not otherwise open, read, or write to the files.

In sum, the catalog may store information about datasets. The information may include information identifying different versions (i.e., different dataset items) of the datasets. In association with information identifying a particular version (i.e., a particular dataset item) of a dataset, there may be information identifying one or more files that contain the data of the particular dataset version (i.e., the particular dataset item).

The catalog may store information representing a non-linear history of a dataset. Specifically, the history of a dataset may have different dataset branches. Branching may be used to allow one set of changes to a dataset to be made independent and/or concurrently of another set of changes to the dataset. The catalog may store branch names in association with dataset version identifiers for identifying dataset items that belong to a particular dataset branch.

The catalog may provide dataset provenance at the transaction level of granularity. As an example, suppose a transformation is executed in the data management system 160 multiple times that reads data from dataset A, reads data from dataset B, transforms the data from dataset A and the data from dataset B in some way to produce dataset C. As mentioned, this transformation may be performed multiple times. Each transformation may be performed in the context of a transaction. For example, the transformation may be performed daily after datasets and B are updated daily in the context of transactions. The result being multiple versions of dataset A, multiple versions of dataset B, and multiple versions of dataset C as a result of multiple executions of the transformation. The catalog may contain sufficient information to trace the provenance of any version of dataset C to the versions of datasets A and B from which the version of dataset C is derived. In addition, the catalog may contain sufficient information the trace the provenance of those versions of datasets A and B to the earlier versions of datasets A and B from which those versions of datasets A and B were derived.

The provenance tracking ability is the result of recording in the catalog for a transaction that creates a new dataset version, the transaction or transactions that the given transaction depends on (e.g., is derived from). The information recorded in the catalog may include an identifier of each dependent transaction and a branch name of the dataset that the dependent transaction was committed against.

According to some embodiments, provenance tracking extends beyond transaction level granularity to column level granularity. For example, suppose a dataset version A is structured as a table of two columns and a dataset version B is structured as a table of five columns. Further assume, column three of dataset version B is computed from column one of dataset version A. In this case, the catalog may store information reflecting the dependency of column three of dataset version B on column one of dataset version A.

The catalog may also support the notion of permission transitivity. For example, suppose the catalog records information for two transactions executed against a dataset referred to in this example as “Transaction 1” and “Transaction 2.” Further suppose a third transaction is performed against the dataset which is referred to in this example as “Transaction 3.” Transaction 3 may use data created by Transaction 1 and data created by Transaction 2 to create the dataset item of Transaction 3. After Transaction 3 is executed, it may be decided according to organizational policy that a particular user should not be allowed to access the data created by Transaction 2. In this case, as a result of the provenance tracking ability, and in particular because the catalog records the dependency of Transaction 3 on Transaction 2, if permission to access the data of Transaction 2 is revoked from the particular user, permission to access the data of Transaction 3 may be transitively revoked from the particular user.

The transitive effect of permission revocation (or permission grant) can apply to an arbitrary number of levels in the provenance tracking. For example, returning to the above example, permission may be transitively revoked for any transaction that depends directly or indirectly on the Transaction 3.

According to some embodiments, where provenance tracking in the catalog has column level granularity. Then permission transitivity may apply at the more fine-grained column level. In this case, permission may be revoked (or granted) on a particular column of a dataset and based on the column-level provenance tracking in the catalog, permission may be transitively revoked on all direct or indirect descendent columns of that column.

A build service can manage transformations which are executed in the system to transform data. The build service may leverage a directed acyclic graph data (DAG) structure to ensure that transformations are executed in proper dependency order. The graph can include a node representing an output dataset to be computed based on one or more input datasets each represented by a node in the graph with a directed edge between node(s) representing the input dataset(s) and the node representing the output dataset. The build service traverses the DAG in dataset dependency order so that the most upstream dependent datasets are computed first. The build service traverses the DAG from the most upstream dependent datasets toward the node representing the output dataset rebuilding datasets as necessary so that they are up to date. Finally, the target output dataset is built once all of the dependent datasets are up to date.

The data management system 160 can support branching for both data and code. Build branches allow the same transformation code to be executed on multiple branches. For example, transformation code on the master branch can be executed to produce a dataset on the master branch or on another branch (e.g., the develop branch). Build branches also allow transformation code on a branch to be executed to produce datasets on that branch. For example, transformation code on a development branch can be executed to produce a dataset that is available only on the development branch. Build branches provide isolation of re-computation of graph data across different users and across different execution schedules of a data pipeline. To support branching, the catalog may store information represents a graph of dependencies as opposed to a linear dependency sequence.

The data management system 160 may enable other data transformation systems to perform transformations. For example, suppose the system stores two “raw” datasets R1 and R2 that are both updated daily (e.g., with daily web log data for two web services). Each update creates a new version of the dataset and corresponds to a different transaction. The datasets are deemed raw in the sense that transformation code may not be executed by the data management system 160 to produce the datasets. Further suppose there is a transformation A that computes a join between datasets R1 and R2. The join may be performed in a data transformation system such a SQL database system, for example. More generally, the techniques described herein are agnostic to the particular data transformation engine that is used. The data to be transformed and the transformation code to transform the data can be provided to the engine based on information stored in the catalog including where to store the output data.

According to some embodiments, the build service supports a push build. In a push build, rebuilds of all datasets that depend on an upstream dataset or an upstream transformation that has been updated are automatically determined based on information in the catalog and rebuilt. In this case, the build service may accept a target dataset or a target transformation as an input parameter to a push build command. The build service than determines all downstream datasets that need to be rebuilt, if any.

As an example, if the build service receives a push build command with dataset R1 as the target, then the build service would determine all downstream datasets that are not up to date with respect to dataset R1 and rebuild them. For example, if dataset D1 is out-of-date with respect to dataset R1, then dataset D1 is rebuilt based on the current versions of datasets R1 and R2 and/or the current version of transformation A. If dataset D1 is rebuilt because it is out-of-date, then dataset D2 will be rebuilt based on the up-to-date version of dataset D1 and the current version of transformation B and so on until all downstream dataset of the target dataset are rebuilt. The build service may perform similar rebuilding if the target of the push build command is a transformation.

The build service may also support triggers. In this case, a push build may be considered a special case of a trigger. A trigger, generally, is a rebuild action that is performed by the build service that is triggered by the creation of a new version of a dataset or a new version of a transformation in the system.

A schema metadata service can store schema information about files that correspond to transactions reflected in the catalog. An identifier of a given file identified in the catalog may be passed to the schema metadata service and the schema metadata service may return schema information for the file. The schema information may encompass data schema related information such as whether the data in the file is structured as a table, the names of the columns of the table, the data types of the columns, user descriptions of the columns, etc.

The schema information can be accessible via the schema metadata service may versioned separately from the data itself in the catalog. This allows the schemas to be updated separately from datasets and those updates to be tracked separately. For example, suppose a comma separated file is uploaded to the system as particular dataset version. The catalog may store in association with the particular dataset version identifiers of one or more files in which the CSV data is stored. The catalog may also store in association with each of those one or more file identifiers, schema information describing the format and/or type of data stored in the corresponding file. The schema information for a file may be retrievable via the scheme metadata service given an identifier of the file as input. Note that this versioning scheme in the catalog allows new schema information for a file to be associated with the file and accessible via the schema metadata service. For example, suppose after storing initial schema information for a file in which the CSV data is stored, updated the schema information is stored that reflects a new or better understanding of the CSV data stored in the file. The updated schema information may be retrieved from the schema metadata service for the file without having to create a new version of the CSV data or the file in which the CSV data is stored.

When a transformation is executed, the build service may encapsulate the complexities of the separate versioning of datasets and/or schema information. For example, suppose transformation A described above in a previous example that accepts the dataset R1 and dataset R2 as input is the target of a build command issued to the build service. In response to this build command, the build service may determine from the catalog the file or files in which the data of the current versions of datasets R1 and R2 is stored. The build service may then access the schema metadata service to obtain the current versions of the schema information for the file or files. The build service may then provide all of identifiers or paths to the file or files and the obtained schema information to the data transformation engine to execute the transformation A. The underlying data transformation engine interprets the schema information and applies it to the data in the file or files when executing the transformation A.

### Object-Centric Data Model

FIG. 2 illustrates an object-centric conceptual data model according to an embodiment. In this example, a database system 210 using an ontology 205 will be described.

This description is provided for the purpose of providing an example and is not intended to limit the techniques to the example data model, the example database system, or the example database system's use of an ontology to represent information.

In one embodiment, a body of data is conceptually structured according to an object-centric data model represented by ontology 205. The conceptual data model is independent of any particular database used for durably storing one or more database(s) 209 based on the ontology 205. For example, each object of the conceptual data model may correspond to one or more rows in a relational database or an entry in Lightweight Directory Access Protocol (LDAP) database, or any combination of one or more databases.

An ontology 205, as noted above, may include stored information providing a data model for storage of data in the database 209 (such as, time series database 116). The ontology 205 may be defined by one or more object types, which may each be associated with one or more (time series) property types. At the highest level of abstraction, data object 201 is a container for information representing things in the world. For example, data object 201 can represent an entity such as a person, a place, an organization, a market instrument, or other noun. Data object 201 can represent an event that happens at a point in time or for a duration. Data object 201 can represent a document or other unstructured data source such as an e-mail message, a news report, or a written paper or article. Each data object 201 is associated with a unique identifier that uniquely identifies the data object within the database system.

Different types of data objects may have different property types. For example, a “Person” data object might have an “Eye Color” property type and an “Event” data object might have a “Date” property type. Each property 203 as represented by data in the database system 210 may have a property type defined by the ontology 205 used by the database 209.

Objects may be instantiated in the database 209 in accordance with the corresponding object definition for the particular object in the ontology 205. For example, a specific monetary payment (e.g., an object of type “event”) of US$30.00 (e.g., a property of type “currency”) taking place on Mar. 27, 2009 (e.g., a property of type “date”) may be stored in the database 209 as an event object with associated currency and date properties as defined within the ontology 205. The data objects defined in the ontology 205 may support property multiplicity. In particular, a data object 201 may be allowed to have more than one property 203 of the same property type. For example, a “Person” data object might have multiple “Address” properties or multiple “Name” properties.

Each link 202 represents an association between two data objects 201. In one embodiment, the association is either through a relationship, an event, or through matching properties. A relationship association may be asymmetrical or symmetrical. For example, “Person” data object A may be connected to “Person” data object B by a “Child Of” relationship (where “Person” data object B has an asymmetric “Parent Of” relationship to “Person” data object A), a “Kin Of” symmetric relationship to “Person” data object C, and an asymmetric “Member Of” relationship to “Organization” data object X. The type of relationship between two data objects may vary depending on the types of the data objects. For example, “Person” data object A may have an “Appears In” relationship with “Document” data object Y or have a “Participate In” relationship with “Event” data object E. As an example of an event association, two “Person” data objects may be connected by an “Airline Flight” data object representing a particular airline flight if they traveled together on that flight, or by a “Meeting” data object representing a particular meeting if they both attended that meeting. In one embodiment, when two data objects are associated by an event, they are also associated by relationships, in which each data object has a specific relationship to the event, such as, for example, an “Appears In” relationship.

As an example of a matching properties association, two “Person” data objects representing a brother and a sister, may both have an “Address” property that indicates where they live. If the brother and the sister live in the same home, then their “Address” properties likely contain similar, if not identical property values. In one embodiment, a link between two data objects may be established based on similar or matching properties (e.g., property types and/or property values) of the data objects. These are just some examples of the types of connections that may be represented by a link and other types of connections may be represented; embodiments are not limited to any particular types of connections between data objects. For example, a document might contain references to two different objects. For example, a document may contain a reference to a payment (one object), and a person (a second object). A link between these two objects may represent a connection between these two entities through their co-occurrence within the same document.

Each data object 201 can have multiple links with another data object 201 to form a link set 204. For example, two “Person” data objects representing a husband and a wife could be linked through a “Spouse Of” relationship, a matching “Address” property, and one or more matching “Event” properties (e.g., a wedding). Each link 202 as represented by data in a database may have a link type defined by the database ontology used by the database.

### Example Diagrams

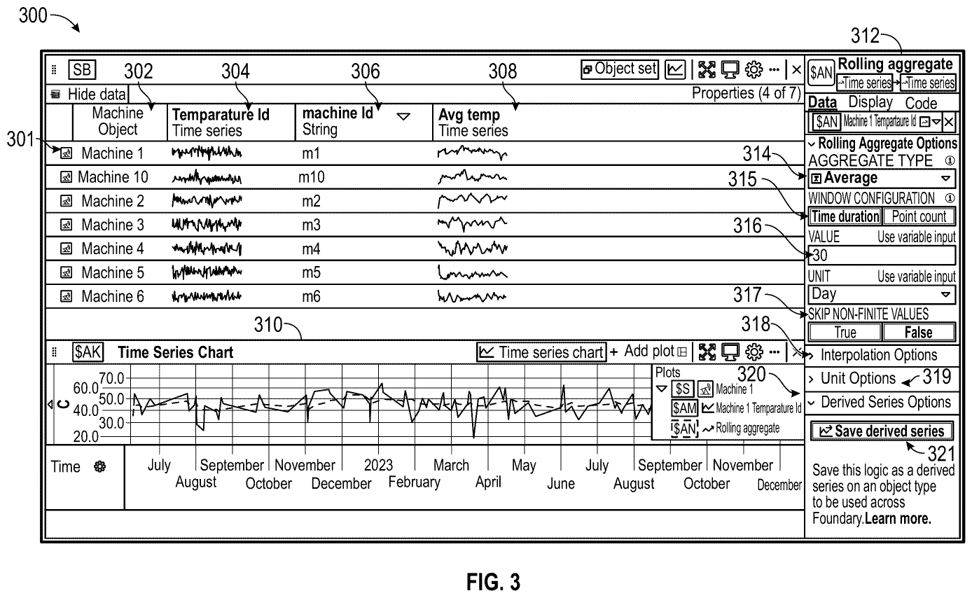

FIG. 3 illustrates an example user interface 300 of an application that is configured to interact with a user to setup and display a derived time series. In this example, an object column 302 lists multiple objects, such as multiple machine objects that have associated time series data (e.g., recorded by sensors associated with the machine objects). The objects listed in column 302 may be selected by a filtering process that is applied by the user, such as to select machine objects at a particular location, ID, type, having data outside of a particular range, etc. In this example, each of the machine objects has an associated temperature time series dataset.

In the example of FIG. 3, a time series visualization column 304 provides a thumbnail visualization of each of the time series. The visualizations may be line charts, as in FIG. 3, or any other chart or visualization type. A machine ID column 306 shows an identifier of each of the machines. A derived time series visualization column 308 shows a thumbnail visualization of each of the derived time series datasets. In this example, the derived time series are generated from an average temperature transformation logic that is defined in transformation logic editor 312.

In the example of FIG. 3, the first machine 301 is selected, causing an enlarged visualization of the time series and derived time series to be displayed in the visualization pane 310. The user may select another of the objects in column 302 to cause display of their corresponding time series and derived time series in the visualization pane 310.

The transformation logic editor 312 allows the user to change the transformation logic that is applied to each of the time series associated with the listed objects. The user may select from existing aggregate types 314 (e.g., average, smoothing, normalizing, interpolating, etc. and may select a time duration 315 or a point count 316 to which the transformation logic should be applied. In this example, the user is provided with additional options to skip non-finite values 317 and to adjust interpolation options 318, unit options 319, and derived series options 320. When the transformation logic indicated in the logic editor 312 is satisfactory, the user can click the save button 321 to store the transformation for later use, such as when analyzing the same types of data and/or data from the same data objects.

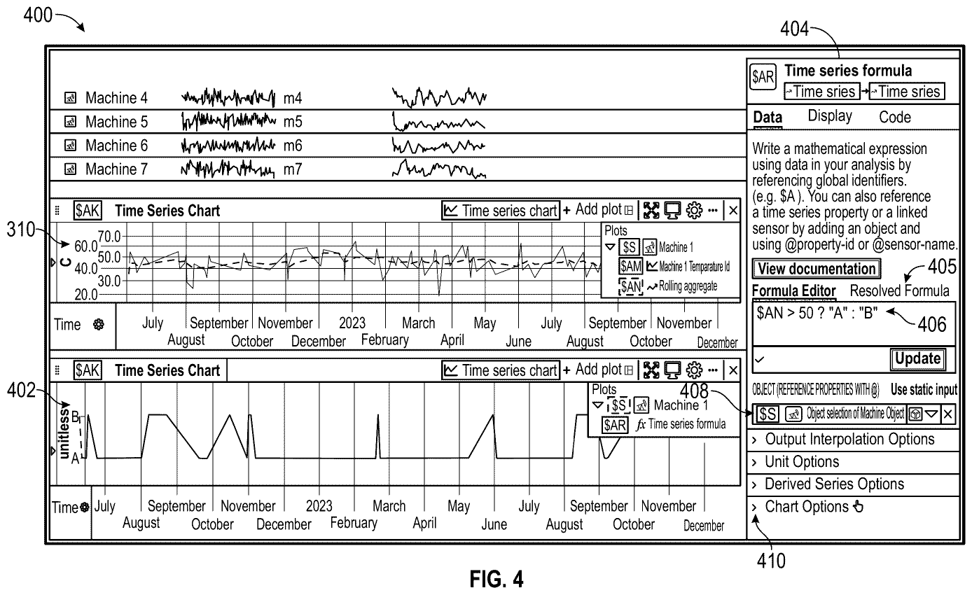

FIG. 4 illustrates an example GUI 400 configured to display various components related to a categorical time series. In general, a categorical time series associates each of the time series values with a category, based on criteria related to each category. For example, each of n categories may be associated with a range of values. In the example of FIG. 4, a categorical time series line chart 402 displays an enlarged visualization of a derived time series created based on the categorical transformation logic 406 in the transformation logic editor 404. In this example, the user interface also includes the visualization pane 310 of FIG. 3, illustrating a derived time series of time series data from Machine 1.

In the example of FIG. 4, the transformation logic editor 404 allows the user to create and edit transformation logic that is applied to a time series (or already derived time series) to create a categorical time series. For example, the user may edit the categorical transformation logic 406 in the formula editor 405. In this example, the categorical transformation logic 406 determines whether data values in the reference object (e.g., the series average rolling temperature derived time series displayed in visualization pane 310) is greater than 50. If a data value is greater than 50, the derived time series is assigned a value of “A”, (and displayed as shown in categorical time series line chart 402). If a data value is less than 50, the derived time series is assigned a value of “B” (and displayed as shown in categorical time series line chart 402).

In the example of FIG. 4, the categorical transformation logic 406 references the data object “$S” corresponding to the first machine 301, which allows the user to reference the rolling aggregate derived time series (“$AN”) and/or the raw time series (“$AM”) in the formula editor 405. The user may alternatively select a different data object in the object selector 408 to reference time series and/or derived time series for different objects (such as, any of the machine objects listed in object column 302). The user may also adjust the chart options 410 to adjust the categorical time series line chart 402 displayed.

FIG. 5 illustrates an example user interface 500 illustrating an overview of a stored derived time series. In this example, the user 120 may edit the metadata 502 for the derived time series, such as the title and description.

In the example of FIG. 5, a delta pressure derived time series logic 501 is selected and applied to Machine 1 that is selected in the object selector 503, causing an enlarged visualization of a generated delta pressure derived times series to be displayed in the preview pane 508. The user may select to preview the delta transformation applied to a different object with the object selector 503.

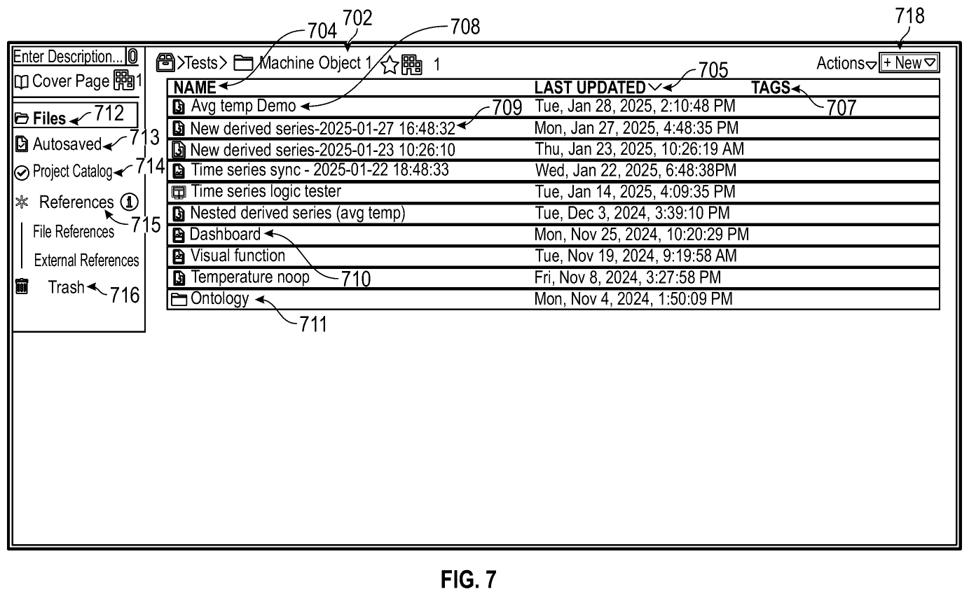

In the example of FIG. 5, the user can review the stored metadata 504 of the derived time series. The stored metadata 504 of the derived time series may include information pertaining to the object types assigned to the derived time series when it was created, such as the bound object 511 and the root object 512. Additionally, the stored metadata 504 may include dates such as the date the derived time series was last updated 513 and the date the derived time series was created 514. Additionally, the stored metadata 504 may include the storage location 515 in the file system of the derived time series (as described further with reference to FIG. 7) and a logic relative identifier (Logic RID 516) assigned to the derived time series when it was created.

The ontology status indicator 510 allows the user to review the current status of the derived time series as deployed in the ontology 205. The user can view the derived time series current utilization 517, such as the root object (e.g., Machine objects) and how many root objects are using the delta pressure transformation logic. Additionally, the user can select the drop down 518 to view details of the objects that are currently using the transformation logic. The user may also confirm with the status indicator 519 that the ontology 205 is updated with the newest derived time series information.

Once the user is finished, the user may choose the save button 522 to save the overview, or the deploy button 524 to deploy the previewed changes to the ontology 205. A version selector 520 may be selected to switch between the current overview, or any previously saved version.

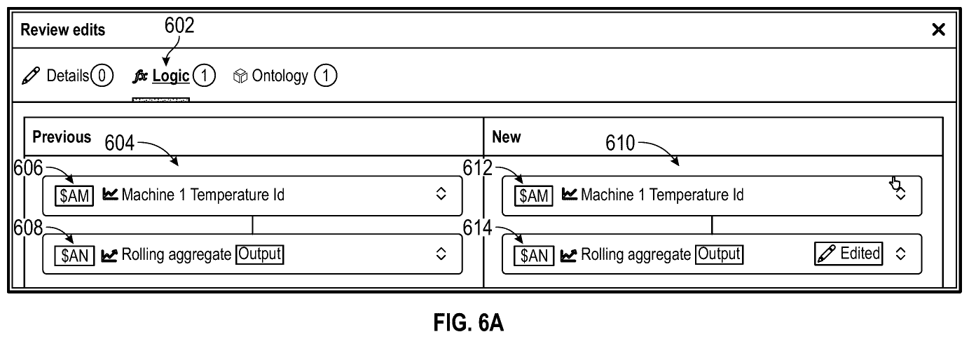

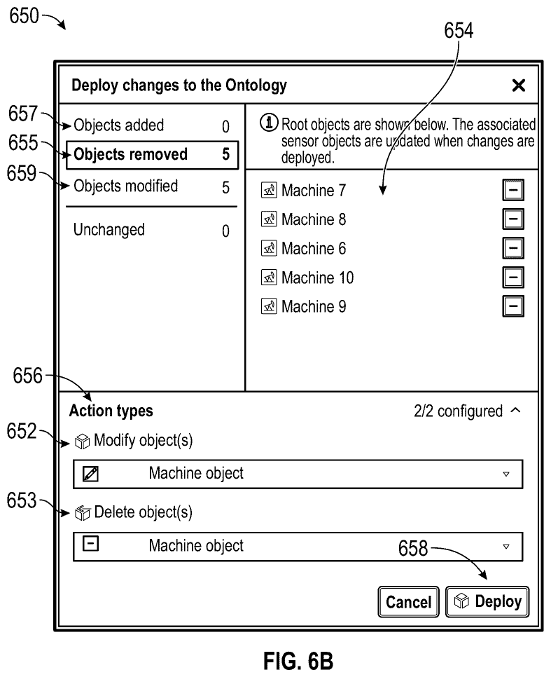

FIG. 6A illustrates an example derived time series review user interface 600 configured to display a comparison of a previous transformation logic and current transformation logic applied to a time series. In this example, the user may review changes made to transformation logic 602 for a rolling aggregate transformation logic.

In the example of FIG. 6A, the user interface 600 displays previous derived time series information 604 and new derived time series information 610. The previous derived time series information 604 may include panels displaying the linked time series property 606 and the transformation logic 608. The new derived time series information 610 may include the linked time series property 612 and an edited transformation logic 614, as indicated by the “edited” included on the edited transformation logic 614 panel.

In the example of FIG. 6A, the user may select the edited transformation logic 614 panel to review the specific edits made to transformation logic. In some embodiments, the linked time series property 612 may have been edited. In such embodiments, the linked time series property 612 panel would display the “edited” information, and the user could select the linked time series property 612 panel to view the changes.

FIG. 6B illustrates an example user interface 650 configured to display and deploy changes to the ontology, such as changes that may be defined in a “template” that is associated with a particular transformation logic. For example, a transformation logic defined by a user may be stored as a template that includes object criteria usable to identify objects to which the transformation logic should be made available (e.g., automatically in response to a user accessing ontology data of the objects). A template may define a particular machine type, data type, sensor type, geographic area, user group, and/or any other criteria associated with time series data. For example, a template may be applied to each machine object of a certain type (e.g., a weather station object) or having certain sensor data (e.g., ambient temperate measurements). The template may be stored in the ontology so that the associated transformation logic is automatically made available to a user accessing an object matching the object criteria of the template.

In the example of FIG. 6B, the user can select an added objects tab 657 to view objects that would be added upon deployment of the changes to the ontology (e.g., changes to template criteria), a objects removed tab 655 to view objects that would be removed (e.g., disassociated with the transformation logic) upon deployment of the changes to the ontology, or an objects modified tab 659 to view objects that would be modified (e.g., the link to the derived time series will not be deleted) upon deployment of the changes to the ontology. In this example, the objects removed tab 655 is selected so the objects panel 654 lists objects that would be removed from association with the transformation logic.

In the example of FIG. 6B, the user interface 650 displays the action types 656 that were utilized to identify modify objects 652 and deleted object objects 653. In some embodiments, an add objects action type could be used to identify additional machine objects to link to the transformation logic. If the user is satisfied with the changes and finished reviewing, they may select the deploy button 658 to deploy the changes to the ontology 205.

FIG. 7 illustrates an example file explorer GUI 700 that shows time series related files, such as transformation logic, charts (or other visualizations), ontology associations, and/or other files that are associated with the selected machine object. In this example, the file list 712 associated with the selected machine object 702 is displayed. The file list 712 can include the files name 704, the files modified date 705, and/or any other similar metadata tags 707. Included in the file list 712 are files associated with the selected machine object 702, which may include time series, such as time series file 708, derived time series, such as derived time series file 709, charts and/or other visualizations related to the selected machine object 702 time series/derived time series, an example dashboard displaying the selected machine object 702, such as example dashboard file 710, and/or an ontology file storage 711 containing ontology associations for the selected machine object 702. The file system may include the files shown in the file explorer GUI 700 and/or any other file saved in association with the selected machine object 702.

In the example of FIG. 7, the file list 712 is displayed. In other examples, other file lists can be displayed. For example, a list of autosaved files 713, a catalog of projects 714 associated with the selected machine object 702, references 715, such as references to the he selected machine object 702 stored within the files and/or references external to the selected files, or the deleted files 716 can alternatively be displayed in the file explorer GUI 700.

If the user wishes to create a new file (such as, a new derived time series visualization), the user may select the create new button 718.

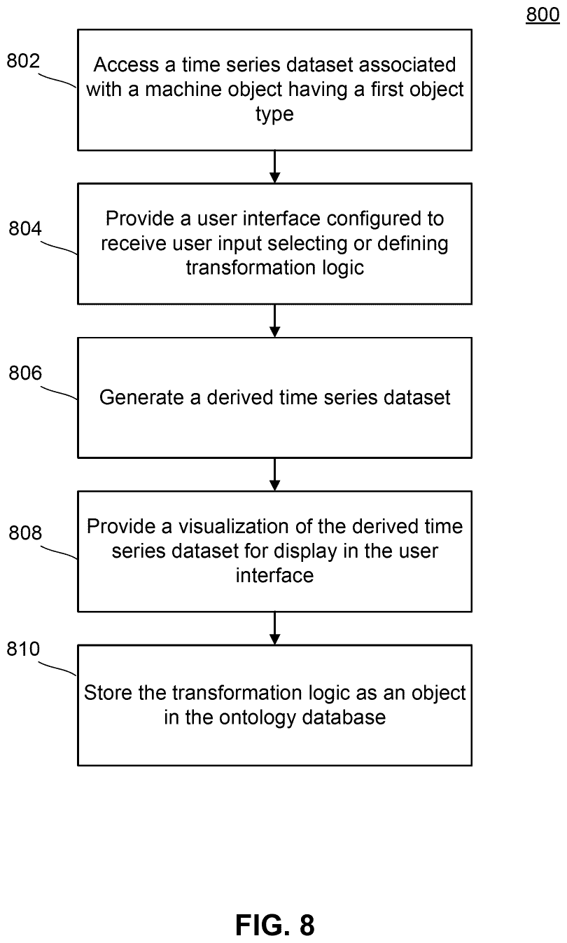

FIG. 8 is a flow chart illustrating an example process 800 for generating and storing a derived time series dataset. The process 800, or portions thereon, can be implemented by a computing device such as a hardware processor. In some embodiments, the process 800, or portions thereon, can be performed by a computing device associated with derived time series computing environment 100, such as the database management system 110.

At block 802, in some embodiments, the system (e.g., database management system 110) can access a time series dataset from a database (e.g., time series database 116). The time series dataset can include a plurality of data values each associated with a respective timestamp. In some embodiments, the time series dataset can be associated with a machine object having a first object type. For example, a temperature time series dataset can contain a plurality of temperatures of a machine object taken over a period of time (e.g., at regular time intervals) and associated with a timestamp of when the temperature was taken.

At block 804, in some embodiments, the system can provide a user interface to a user (e.g., user 120) configured to receive user input selecting predefined transformation logic (e.g., transformation logic 114A) from a transformation logic database (e.g., transformation logic database 114). Alternatively, the user may define a new transformation logic usable to transform the time series dataset.

As described herein, in some embodiments, the transformation logic may include, for each of a plurality of categories, category criteria defining time series values associated with the category. In some embodiments, a category criteria may be a range of values associated with that category. For example, a first category criteria associated with a first category may specify values above a threshold value and a second category criteria associated with a second category specifies values below the threshold value. Alternatively, any n number of ranges can be used for n number of categories in the transformation logic.

At block 806, in some embodiments, the system can generate a derived time series dataset. The derived time series data can be generated based on the time series dataset and the transformation logic. For example, the time series dataset can contain data values for a machine object's temperature over time, and the transformation logic can be a formula configured to find the average rolling temperature given a set of values. In this example, an average rolling temperature derived time series dataset can be generated from the temperature time series dataset and the average rolling temperature transformation logic.

As another example, in some embodiments, at block 806, generating the derived time series dataset may comprise, for each data value of the time series dataset, assigning a category to the data value. For example, the transformation logic can be configured to assigned temperatures from a temperature time series dataset with a value greater than 50 to the first category “A”, and temperatures less than 50 can be assigned to the second category “B”.

In some embodiments, the system can generate a visualization indicating the assigned categories of the data values. For example, a line chart (e.g., categorical time series line chart 402) can be generated to display the temperature data values assigned to “A” and the data values assigned to “B”.

At block 808, in some embodiments, the system can provide a visualization of the derived time series dataset for display in the user interface. For example, a visualization pane (e.g., visualization pane 310) can display an enlarged visualization of the derived time series dataset. In other embodiments, the visualization pane can display an enlarged visualization of the categorical derived time series dataset or the templated derived time series dataset.

At block 810, in some embodiments, the system can store the transformation logic as an object in the ontology database. The transformation logic can be associated with a first machine object and/or a plurality of other machine objects of the first object type. For example, average rolling temperature transformation logic can be associated with a machine object 1, which outputs a temperature time series dataset. The average rolling temperature transformation logic can also be associated with any number of machine objects 2-n which also output a temperature time series dataset.

In some embodiments, the transformation logic can be selectable by a plurality of users which are accessing the plurality of machine objects of the first object type. For example, any user who is accessing a machine object which outputs a temperature time series dataset can select the average rolling temperature transformation logic and apply it to the time series dataset to generate a derived time series.

Although the example of FIG. 8 discusses an example process 800 of generating and storing a derived time series, this is not intended to be limited. Fewer, more, or different blocks could be included in the process 800. For example, although the process 800 references user input for selecting or defining one transformation logic, it should be understood that in certain embodiments a user can select or define a second transformation logic. The second transformation logic may be usable to transform the first derived time series dataset. Similarly, the system can generate a second derived time series dataset based on the first derived time series dataset and the second transformation logic. For example, an average rolling derived time series dataset could be generated. The user may then select a derivative transformation logic and apply that to the average rolling derived time series dataset to generate a derivative derived time series dataset. Additionally, the system can provide a visualization of the second (e.g., derivative) derived time series dataset for display in the user interface.

In some embodiments, the system can further receive user input indicating changes to the transformation logic. The system can store the changed transformation logic in the ontology database. The changed transformation logic can be automatically associated with each of the plurality of machine objects of the first object type. Additionally, the changed transformation logic can be used to generate an updated derived time series dataset based on the associated time series datasets of the plurality of machine objects and the changed transformation logic.

In some embodiments, the system can receive user input adjusting the machine object criteria used to associate the transformation logic with machine objects. For example, the machine object criteria can indicate one or more of a sensor type, a machine type, a machine location, and/or a machine identifier. The system can automatically associate the transformation logic with new machine objects based on the updated machine object criteria. For example, a user may change the warehouse location that houses machine objects that the user wants the transformation logic to apply to. In this example, the system can automatically associate the transformation logic with machine objects in the new warehouse location that match the machine object criteria. The machine object criteria can be stored as a template in the ontology database.

In some embodiments, the system can access an updated time series dataset that is associated with the machine object and automatically generate an updated derived time series dataset based on the updated time series dataset and the transformation logic. For example, if the temperature time series dataset is updated with additional time series data, the system can automatically regenerate the average rolling derived time series dataset by applying the transformation logic to the updated time series dataset. For example, the user may setup a rule or condition that triggers recalculation of the derived time series (based on real-time application of transformation logic) in response to a trigger, such as a detected updated in the time series data, opening a particular dashboard, or any other user or system action. In some embodiments, the user may specifically request recalculation of a derived data set, either based on the same time series data or based, updated time series data, or a completely different time series dataset.

In some embodiments, the system can receive a request from a second user to transform a second time series dataset that is associated with a second machine object of the first object type. The system can determine that the requested transformation logic is associated with the first object type for the machine objects and automatically generate a second derived time series dataset based on the second time series dataset and the transformation logic. For example, a second user may select the temperature time series dataset on machine object 2. The system can determine that machine object 2 is associated with the same machine object type as machine object 1 and can automatically generate the average rolling temperature derived time series from the temperature time series dataset of machine object 2.

### Example Clauses

Examples of the implementations of the present disclosure can be described in view of the following example clauses (and the example clauses provided above). The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computerized method, performed by a computing system having one or more hardware computer processors and one or more non-transitory computer readable storage device storing software instructions executable by the computing system to perform the computerized method comprising: accessing a time series dataset associated with a machine object having a first object type, the time series including a plurality of data values each associated with a respective timestamp; providing a user interface configured to receive user input selecting or defining transformation logic usable to transform the time series dataset; generating a derived time series dataset based on the time series dataset and the transformation logic; providing for display in the user interface a visualization of the derived time series dataset; and storing the transformation logic as an object in an ontology database in association with a the first machine object and a plurality of other machine objects of the first object type, wherein the transformation logic is selectable by any of a plurality of users accessing any of the plurality of machine objects of the first type.

Clause 2. The computerized method of clause 1, further comprising: receiving user input selecting or defining a second transformation logic usable to transform the derived time series dataset; generating a second derived time series dataset based on the derived time series dataset and the second transformation logic; and providing for display in the user interface a visualization of the second derived time series dataset.

Clause 3. The computerized method of clause 1, further comprising: receiving user input indicating changes to the transformation logic; storing the changed transformation logic in the database, wherein the changed transformation logic is automatically associated with each of the plurality of machine objects of the first type and usable to generate an updated derived time series dataset based on respective time series datasets of the machine objects.

Clause 4. The computerized method of clause 1, further comprising: receiving user input indicating machine object criteria; and automatically associating the transformation logic with machine objects matching the machine object criteria.

Clause 5. The computerized method of clause 4, wherein the machine object criteria is stored as a template in the ontology database.

Clause 6. The computerized method of clause 4, wherein the machine object criteria indicates one or more of a sensor type, a machine type, a machine location, or a machine identifier.

Clause 7. The computerized method of clause 1, wherein the transformation logic includes, for each of a plurality of categories, category criteria defining time series values associated with the category.

Clause 8. The computerized method of clause 7, wherein a first category criteria associated with a first category specifies values above a threshold value and a second category criteria associated with a second category specifies values below the threshold value.

Clause 9. The computerized method of clause 7, wherein said generating the derived time series dataset comprises: for each data value of the time series dataset: assigning, based on the category criteria, a category to the data value; generating a visualization indicating the assigned categories of the data values.

Clause 10. The computerized method of clause 1, further comprising: accessing an updated time series dataset associated with the machine; and automatically generating an updated derived time series dataset based on the updated time series dataset and the transformation logic.

Clause 11. The computerized method of clause 1, further comprising: receiving a request from a second user for second times series data associated with a second machine object of the first type; determining that the transformation logic is associated with the first type of machine object; and automatically generating a second derived time series dataset based on the second time series dataset and the transformation logic.

Clause 12. A computing system comprising: a hardware computer processor; and a non-transitory computer readable medium having software instructions stored thereon, the software instructions executable by the hardware computer processor to cause the computing system to perform operations comprising: accessing a time series dataset associated with a machine object having a first object type, the time series including a plurality of data values each associated with a respective timestamp; providing a user interface configured to receive user input selecting or defining transformation logic usable to transform the time series dataset; generating a derived time series dataset based on the time series dataset and the transformation logic; providing for display in the user interface a visualization of the derived time series dataset; and storing the transformation logic as an object in an ontology database in association with a the first machine object and a plurality of other machine objects of the first object type, wherein the transformation logic is selectable by any of a plurality of users accessing any of the plurality of machine objects of the first type.

Clause 13. The computing system of clause 12, wherein the operations further comprise: receiving user input selecting or defining a second transformation logic usable to transform the derived time series dataset; generating a second derived time series dataset based on the derived time series dataset and the second transformation logic; and providing for display in the user interface a visualization of the second derived time series dataset.

Clause 14. The computing system of clause 12, wherein the operations further comprise: receiving user input indicating changes to the transformation logic; and storing the changed transformation logic in the database, wherein the changed transformation logic is automatically associated with each of the plurality of machine objects of the first type and usable to generate an updated derived time series dataset based on respective time series datasets of the machine objects.

Clause 15. The computing system of clause 12, wherein the operations further comprise: receiving user input indicating machine object criteria; and automatically associating the transformation logic with machine objects matching the machine object criteria.

Clause 16. The computing system of clause 15, wherein the machine object criteria is stored as a template in the ontology database.

Clause 17. The computing system of clause 15, wherein the machine object criteria indicates one or more of a sensor type, a machine type, a machine location, or a machine identifier.

Clause 18. The computing system of clause 12, wherein the transformation logic includes, for each of a plurality of categories, category criteria defining time series values associated with the category.

Clause 19. The computerized method of clause 18, wherein a first category criteria associated with a first category specifies values above a threshold value and a second category criteria associated with a second category specifies values below the threshold value.

Clause 20. The computing system of clause 12, wherein the operations further comprise: accessing an updated time series dataset associated with the machine; and automatically generating an updated derived time series dataset based on the updated time series dataset and the transformation logic.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

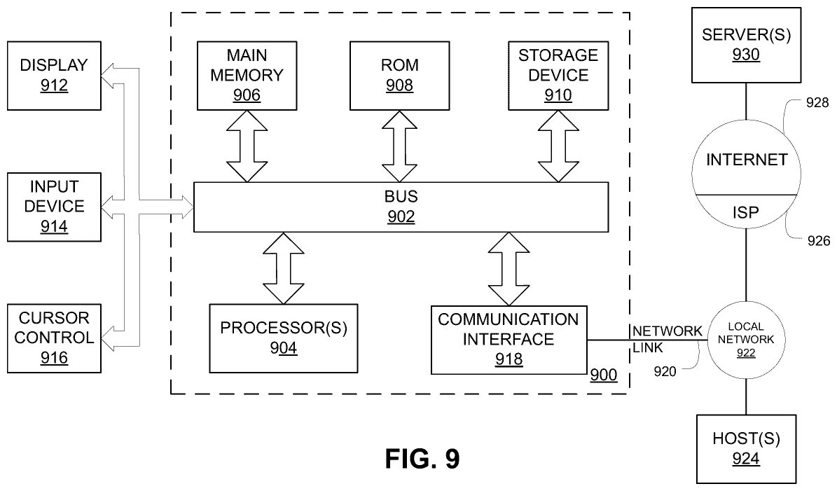

For example, FIG. 9 is a block diagram that illustrates a computer system 900 upon which various embodiments may be implemented. Computer system 900 includes a bus 902 or other communication mechanism for communicating information, and a hardware processor, or multiple processors, 804 coupled with bus 902 for processing information. Hardware processor(s) 904 may be, for example, one or more general purpose microprocessors.

Computer system 900 also includes a main memory 906, such as a random-access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

Computer system 900 may be coupled via bus 902 to a display 912, such as a cathode ray tube (CRT) or LCD display (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computer system 900 may include a user interface module to implement a GUI that may be stored in a mass storage device as computer executable program instructions that are executed by the computing device(s). Computer system 900 may further, as described below, implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more computer readable program instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

Various forms of computer readable storage media may be involved in carrying one or more sequences of one or more computer readable program instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN (or WAN component to communicated with a WAN). Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the worldwide packet data communication network now commonly referred to as the “Internet” 828. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

1. A computerized method, performed by a computing system having one or more hardware computer processors and one or more non-transitory computer readable storage device storing software instructions executable by the computing system to perform the computerized method comprising:
accessing a time series dataset associated with a machine object having a first object type, the time series dataset including a plurality of data values each associated with a respective timestamp;
providing a user interface configured to receive user input selecting or defining transformation logic usable to transform the time series dataset;
generating a first derived time series dataset based on the time series dataset and the transformation logic;
providing for display in the user interface a visualization of the first derived time series dataset; and
storing the transformation logic instead of the derived time series data as an object in an ontology database in association with a first machine object and a plurality of other machine objects of the first object type, wherein the transformation logic is applied during runtime using parameterized inputs referenced via the ontology database, wherein the parameterized inputs are used to retrieve ontology-referenced time-series properties associated with the first machine object to compute one or more of the first derived time series dataset or a second derived time series dataset on demand, wherein the transformation logic is selectable by any of a plurality of users accessing any of the plurality of machine objects of the first object type.

2. The computerized method of claim 1, further comprising:
receiving user input selecting or defining a second transformation logic usable to transform the first derived time series dataset;
generating the second derived time series dataset based on the first derived time series dataset and the second transformation logic; and
providing for display in the user interface a visualization of the second derived time series dataset.

3. The computerized method of claim 1, further comprising:
receiving user input indicating changes to the transformation logic; and
storing the changed transformation logic in the ontology database, wherein the changed transformation logic is automatically associated with each of the plurality of machine objects of the first object type and usable to generate an updated derived time series dataset based on respective time series datasets of the plurality of machine objects.

4. The computerized method of claim 1, further comprising:
receiving user input indicating machine object criteria; and
automatically associating the transformation logic with machine objects matching the machine object criteria.

5. The computerized method of claim 4, wherein the machine object criteria is stored as a template in the ontology database.

6. The computerized method of claim 4, wherein the machine object criteria indicates one or more of a sensor type, a machine type, a machine location, or a machine identifier.

7. The computerized method of claim 1, wherein the transformation logic includes, for each of a plurality of categories, category criteria defining time series values associated with the category.

8. The computerized method of claim 7, wherein a first category criteria associated with a first category specifies values above a threshold value and a second category criteria associated with a second category specifies values below the threshold value.

9. The computerized method of claim 7, wherein said generating the first derived time series dataset comprises:
for each data value of the first time series dataset:
assigning, based on the category criteria, a category to the data value; and
generating a visualization indicating the assigned categories of the data values.

10. The computerized method of claim 1, further comprising:
accessing an updated time series dataset associated with the machine object; and
automatically generating an updated derived time series dataset based on the updated time series dataset and the transformation logic.

11. The computerized method of claim 1, further comprising:
receiving a request from a second user for a second time series dataset associated with a second machine object of the first object type;
determining that the transformation logic is associated with the first object type of machine object; and
automatically generating a third derived time series dataset based on the second time series dataset and the transformation logic.

12. A computing system comprising:
a hardware computer processor; and
a non-transitory computer readable medium having software instructions stored thereon, the software instructions executable by the hardware computer processor to cause the computing system to perform operations comprising:
accessing a time series dataset associated with a machine object having a first object type, the time series dataset including a plurality of data values each associated with a respective timestamp;
providing a user interface configured to receive user input selecting or defining transformation logic usable to transform the time series dataset;
generating a first derived time series dataset based on the time series dataset and the transformation logic;
providing for display in the user interface a visualization of the first derived time series dataset; and
storing the transformation logic instead of the derived time series data as an object in an ontology database in association with a first machine object and a plurality of other machine objects of the first object type, wherein the transformation logic is applied during runtime using parameterized inputs referenced via the ontology database, wherein the parameterized inputs are used to retrieve ontology-referenced time-series properties associated with the first machine object to compute one or more of the first derived time series dataset or a second derived time series dataset on demand, wherein the transformation logic is selectable by any of a plurality of users accessing any of the plurality of machine objects of the first object type.

13. The computing system of claim 12, wherein the operations further comprise:
receiving user input selecting or defining a second transformation logic usable to transform the first derived time series dataset;
generating the second derived time series dataset based on the first derived time series dataset and the second transformation logic; and
providing for display in the user interface a visualization of the second derived time series dataset.

14. The computing system of claim 12, wherein the operations further comprise:
receiving user input indicating changes to the transformation logic; and
storing the changed transformation logic in the ontology database, wherein the changed transformation logic is automatically associated with each of the plurality of machine objects of the first object type and usable to generate an updated derived time series dataset based on respective time series datasets of the plurality of machine objects.

15. The computing system of claim 12, wherein the operations further comprise:
receiving user input indicating machine object criteria; and
automatically associating the transformation logic with machine objects matching the machine object criteria.

16. The computing system of claim 15, wherein the machine object criteria is stored as a template in the ontology database.

17. The computing system of claim 15, wherein the machine object criteria indicates one or more of a sensor type, a machine type, a machine location, or a machine identifier.

18. The computing system of claim 12, wherein the transformation logic includes, for each of a plurality of categories, category criteria defining time series values associated with the category.

19. The computing system of claim 18, wherein a first category criteria associated with a first category specifies values above a threshold value and a second category criteria associated with a second category specifies values below the threshold value.

20. The computing system of claim 12, wherein the operations further comprise:
accessing an updated time series dataset associated with the machine object; and
automatically generating an updated derived time series dataset based on the updated time series dataset and the transformation logic.
